(19) United States
(12) Patent Application Publication
(10) Pub. No.: US 2026/0162647 A1
(43) Pub. Date: Jun. 11, 2026

(54) Methods and Corresponding Electronic Devices for Dynamically Managing Volume and Active Noise Cancelation Modes of Operation

(71) Applicant: Motorola Mobility LLC, Chicago, IL (US)

(72) Inventors: Amit Kumar Agrawal, Bangalore (IN); Himanshu Chug, Bangalore (IN); Shuaib Puzhakkal Kavalathara, Malappuram (IN)

(21) Appl. No.: 18/977,668

(22) Filed: Dec. 11, 2024

(51) Int. Cl. G10K 11/178; G06F 3/16; G10L 25/78; H04R 1/10

(52) U.S. Cl. CPC G10K 11/17885; G06F 3/165; G10L 25/78; H04R 1/1083; H04R 2460/01

(57) ABSTRACT

A method and corresponding electronic devices dynamically manage volume and active noise cancelation (ANC) modes of operation. The method involves determining, by one or more processors, that an audio output device is delivering audio content to a user while operating in a noise cancelation mode. The method further includes determining, from an audio input device, that the user is enunciating words. The processors then determine whether the words are directed to the audio input device or the environment. When the words are directed to the environment, the processors cause the device to transition from noise cancelation mode to transparency mode while lowering the volume level of the audio content. When the words are directed to the audio input device, the device maintains operation in the noise cancelation mode. The system utilizes various sensors and algorithms to enhance detection accuracy and improve user experience.

### BACKGROUND

### Technical Field

This disclosure relates generally to electronic devices, and more particularly to electronic devices having audio output devices.

### Background Art

Portable electronic device usage has become ubiquitous. Vast majorities of the population carry a smartphone, tablet computer, or laptop computer daily to communicate with others, stay in formed, to consume entertainment, and to manage their lives. As the technology incorporated into these portable electronic devices has become more advanced, so too has their feature set. It would be advantageous to have an improved electronic device drawing new functionality from these new features.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory block diagram schematic for an electronic device in accordance with one or more embodiments of the disclosure.

FIG. 3 illustrates one explanatory electronic device operating in conjunction with a companion electronic device, along with one or more method steps, in accordance with one or more embodiments of the disclosure.

FIG. 4 illustrates another explanatory electronic device operating in conjunction with a companion electronic device, along with one or more additional method steps, in accordance with one or more embodiments of the disclosure.

FIG. 5 illustrates still another explanatory electronic device operating in conjunction with a companion electronic device, along with one or more additional method steps, in accordance with one or more embodiments of the disclosure.

FIG. 6 illustrates another explanatory electronic device operating in conjunction with a companion electronic device, along with one or more additional method steps, in accordance with one or more embodiments of the disclosure.

FIG. 7 illustrates one explanatory method in accordance with one or more embodiments of the disclosure.

FIG. 8 illustrates one or more embodiments of the disclosure.

FIG. 9 illustrates a situation embodiments of the disclosure solve.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, by one or more processors, that an audio output device of the electronic device is delivering audio content to a user while the electronic device is operating in a noise cancelation mode of operation, determining, by the one or more processors from an audio input device of the electronic device, that the user is enunciating words, determining, by the one or more processors, whether the words are directed to the audio input device of the electronic device or an environment of the electronic device, and when the words are directed to the environment of the electronic device, causing, by the one or more processors, the electronic device to transition from the noise cancelation mode of operation to a transparency mode of operation while lowering a volume level associated with the audio content. Alternatively, when the words are directed to the audio input of the electronic device, the method can comprise maintaining operation of the electronic device in the noise cancelation mode of operation. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to determining pair of companion electronic devices in communication with the communication device are delivering audio content to a user while the pair of companion electronic devices operate in a noise cancelation mode of operation, determining that the user is speaking to an environment of the electronic device, determining whether words spoken by the user are directed to at least one companion electronic device or to an object situated within the environment, and when the words spoken by the user are directed to the object situated within the environment, delivering other signals to the pair of companion electronic devices causing the pair of companion electronic devices to transition from a noise canceling mode of operation to a transparency mode of operation as described herein. The non-processor circuits may include, but are not limited to, a radio receiver, a radio transmitter, signal drivers, clock circuits, power source circuits, and user input devices.

As such, these functions may be interpreted as steps of a method to perform determining, with a communication device paired with a companion electronic device pair, that the companion electronic device pair is delivering audio content to a user while operating in a noise canceling mode of operation, determining, from signals received by the communication device from one or both companion electronic devices of the companion electronic device pair, that the user is speaking while the companion electronic device pair is delivering the audio content to the user while operating in the noise canceling mode of operation, affirming, by one or more processors, that words spoken by the user are not directed to either companion electronic device of the companion electronic device pair, and when the one or more processors affirm the words spoken by the user are not directed to the either companion electronic device of the companion electronic device pair, causing, by the one or more processors by delivering other signals to the companion electronic device pair, the companion electronic device pair to transition from the noise canceling mode of operation to a transparency mode of operation. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that users of wireless headsets that include active noise cancelation (ANC) features can suffer from inconvenience and potential embarrassment under certain scenarios when ANC is enabled. Embodiments of the disclosure contemplate that such users often engage in various activities such as walking, commuting, or participating in calls while using these headsets since modern headsets equipped with ANC allow users to enjoy immersive audio experiences by minimizing ambient noise.

However, when users initiate conversations while immersed in audio playback, embodiments of the disclosure contemplate that the users may unintentionally speak louder when ANC is enabled due to the reduced feedback volume in their ears. This can lead to awkward situations where the user appears to be shouting, causing discomfort or embarrassment to others nearby.

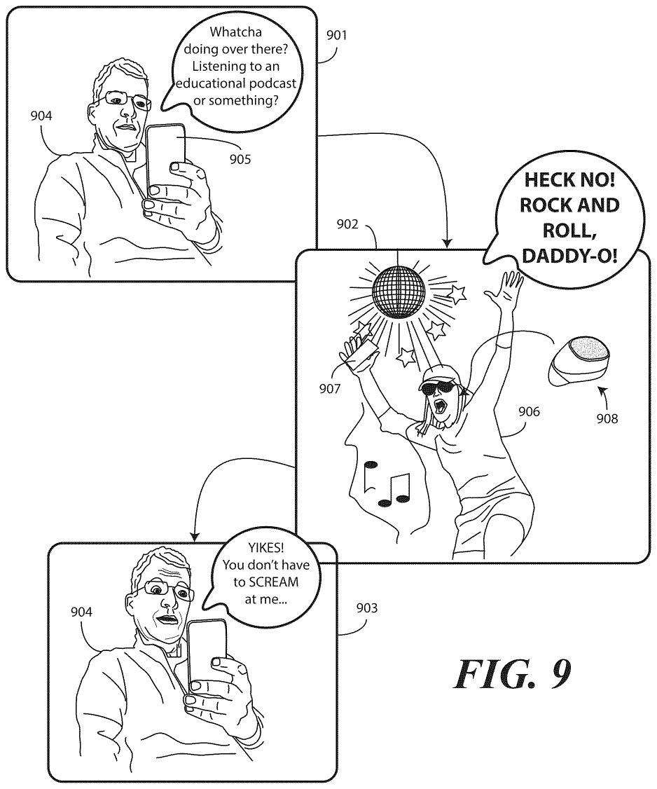

To illustrate, turn briefly to FIG. 9. At step 901 of FIG. 9, a husband 904 is trying to read the local news on his smartphone 905, which reports on the new opening of Buster's Tofu Shack near his home. The husband 904 is particularly excited about this new establishment because Buster's Tofu Shack serves tofu in eight different ways, each offering a delightful culinary experience. Some of the delicious recipes include crispy tofu bites, which are seasoned and fried to a golden crisp, and tofu stir-fry, which combines fresh vegetables and a savory sauce that enhances the natural flavors of the tofu. Another favorite is the tofu scramble, a hearty and satisfying dish that mimics the texture of scrambled eggs, making tofu scramble a breakfast option. Buster's also offers tofu tacos, where the tofu is marinated in a blend of spices and served with fresh salsa and guacamole, providing a burst of flavors in every bite. The husband 904 appreciates the variety and creativity in Buster's menu, which also includes tofu curry, tofu salad, tofu soup, and tofu skewers, each prepared with high-quality ingredients and meticulous attention to detail.

The husband 904 loves the fact that his wife 906 is using wireless earbuds 908 featuring active noise cancelation while she jams to the musical stylings of Mac and Henry's Jazz Fugatorium. With the active noise cancelation feature enabled, the wife 906 is fully immersed in her music, leaving the husband 904 in silence to contemplate his first tofu order from Buster's. This quiet environment allows him to focus on the news article and daydream about the various tofu dishes he plans to try, without any distractions. The wireless earbuds 908 provide a seamless and enjoyable experience for both the husband 904 and the wife 906, as she enjoys her music, and he enjoys the peace and quiet.

At step 902, the wife's smartphone 907 streams the hard swinging, hardbop sounds of Mac and Henry to the wireless earbuds 908. The wife 906, fully immersed in the music, begins to sing. Due to the active noise cancelation feature of the wireless earbuds 908, the wife 906 lacks acoustic feedback from the environment into her ears. Consequently, she starts singing “Heck No! Rock and Roll, Daddy-O,” at an extremely loud level. Despite the incongruity of the lyrics with the hardbop jazz genre of Mac and Henry, the wife 906 remains unaware of her volume. The lack of environmental feedback causes her to emit these words so loudly that even the neighbors can hear her through the walls of the house.

The wireless earbuds 908, equipped with active noise cancelation, isolate the wife 906 from ambient sounds, enhancing her immersion in the music. This isolation, however, results in her unintentional loud singing. The absence of acoustic feedback prevents her from modulating her voice, leading to an excessively loud vocal output. The neighbors, situated in adjacent houses, become unintended listeners to her impromptu performance.

At step 903 of FIG. 9, the husband 904 experiences a sudden shock and slight horror at the wife's loud singing. The volume of her voice, amplified by the active noise cancelation feature of her wireless earbuds 908, disrupts the husband's peaceful contemplation of his upcoming tofu order from Buster's Tofu Shack. The husband's initial excitement about the various tofu dishes, such as crispy tofu bites and tofu stir-fry, quickly dissipates as the wife's loud singing overwhelms his thoughts.

The husband's frustration mounts as he struggles to regain his focus on the news article and his tofu order. The loud singing not only interrupts his train of thought but also creates an uncomfortable atmosphere in the room. The husband's irritation reaches a peak, leading him to exclaim, “Yikes! You don't have to SCREAM at me. . . . ” This outburst reflects his exasperation with the situation, highlighting the need for a system that can dynamically manage volume and active noise cancelation modes to prevent such occurrences. The scenario underscores the need for a system that dynamically manages volume and active noise cancelation modes to prevent such occurrences.

What's more, embodiments of the disclosure also contemplate that even if the wife 906 was aware of the fact that ANC made her sing louder, manually toggling between ANC and transparency modes each time she sings can be cumbersome. While transparency mode allows ambient sounds to be heard, situational awareness is required to manually control the wireless earbuds 908 between the various modes. A user must manually switch between these modes, which disrupts the user experience and can be particularly inconvenient during short, sporadic conversations. The challenge lies in providing a seamless transition between ANC and transparency modes, ensuring that users can converse naturally without the need for manual intervention, thereby enhancing the overall usability and comfort of the wireless headset device.

Advantageously, embodiments of the disclosure provide a solution to this problem. In one or more embodiments, a method involves dynamically managing the media volume and ANC modes of operation of of a wireless headset device to address the issues users face when engaging in conversations while immersed in audio playback. In one or more embodiments, the system employs various sensors and algorithms to detect when the user initiates a conversation. In one or more embodiments, the wireless headset device includes microphones that continuously monitor the user's voice and the surrounding environment. In one or more embodiments, when the system detects that the user is speaking, the system determines whether the conversation is directed towards the device or an external person.

In one or more embodiments, if the conversation is directed towards an external person, the system automatically reduces the media volume and switches from ANC mode to transparency mode. Advantageously, this transition allows the user to hear ambient sounds, facilitating a natural conversation without the need to manually toggle between modes. In one or more embodiments, the system resumes the original media volume and ANC mode once the conversation ends, ensuring a seamless user experience.

In one or more embodiments, the wireless headset device utilizes capacitive sensors, proximity sensors, and inertial measurement units (IMUs) to enhance the detection accuracy. Capacitive sensors enable in-ear detection and gesture control, while IMUs track head movements to provide contextual awareness. The integration of these sensors with AI-based algorithms allows the system to intelligently manage audio playback and ANC modes, thereby improving the overall usability and comfort of the wireless headset device.

In one or more embodiments, a method comprises determining, by one or more processors, that an audio output device of the electronic device is delivering audio content to a user while the electronic device is operating in a noise cancelation mode of operation. In one or more embodiments, the method further includes determining, by the one or more processors from an audio input device of the electronic device, that the user is enunciating words.

In one or more embodiments, the method involves determining, by the one or more processors, whether the words are directed to the audio input device of the electronic device or an environment of the electronic device. When the words are directed to the environment of the electronic device, the method includes causing, by the one or more processors, the electronic device to transition from the noise cancelation mode of operation to a transparency mode of operation while lowering a volume level associated with the audio content. Additionally, when the words are directed to the audio input of the electronic device, the method includes maintaining operation of the electronic device in the noise cancelation mode of operation.

Advantageously, by determining that an audio output device is delivering audio content to a user while operating in a noise cancelation mode, the system can accurately identify when the user is immersed in audio playback. This ensures that the subsequent actions are contextually relevant to the user's current state, enhancing the overall user experience.

Detecting that the user is enunciating words using an audio input device allows the system to recognize when the user is attempting to speak. This detection is beneficial for dynamically managing the audio settings, as it provides the necessary trigger to adjust the audio output and noise cancelation modes.

Determining whether the words are directed to the audio input device, or the environment enables the system to differentiate between conversations intended for the device (such as voice commands or phone calls) and those directed towards external individuals. This distinction allows for appropriately adjusting the audio settings to match the user's intent.

When the words are directed to the environment, transitioning from the noise cancelation mode to a transparency mode while lowering the volume level of the audio content allows the user to hear ambient sounds and converse naturally without the need to manually toggle settings. This automatic adjustment reduces user effort and prevents potential embarrassment from speaking too loudly, thereby improving the usability and comfort of the wireless headset device.

Maintaining the noise cancelation mode when the words are directed to the audio input device ensures that the user continues to benefit from the immersive audio experience during device interactions, such as voice commands or phone calls. This selective adjustment of audio settings based on the context of the conversation enhances the functionality and user experience of the electronic device.

Accordingly, while users of wireless headsets equipped with ANC often face challenges in various scenarios, such as when users initiate conversations while immersed in audio playback, they may unintentionally speak louder due to the reduced feedback volume in their ears. This can lead to awkward situations where the user appears to be shouting, causing discomfort or embarrassment to others nearby.

Additionally, current solutions for managing audio playback and ANC modes in wireless headsets have several disadvantages, such as requiring manual toggling between ANC and transparency modes, which can be cumbersome and disrupt the user experience. The need to manually switch between these modes can be particularly inconvenient during short, sporadic conversations. Additionally, existing systems may not effectively differentiate between conversations directed towards the device and those directed towards external individuals, leading to inappropriate audio adjustments.

Advantageously, embodiments of the disclosure address these issues by dynamically managing the media volume and ANC modes of operation in wireless headset devices. In one or more embodiments, the system employs various sensors and algorithms to detect when the user initiates a conversation. Illustrating by example, in one or more embodiments a wireless headset device includes microphones that continuously monitor the user's voice and the surrounding environment.

In one or more embodiments, when the system detects that the user is speaking, the system determines whether the conversation is directed towards the device or an external person. If the conversation is directed towards an external person, the system automatically reduces the media volume and switches from ANC mode to transparency mode, allowing the user to hear ambient sounds and converse naturally without the need to manually toggle between modes. In one or more embodiments, the system resumes the original media volume and ANC mode once the conversation ends, ensuring a seamless user experience.

In one or more embodiments, an electronic device comprises a communication device and one or more processors operable with the communication device. In one or more embodiments, the one or more processors, in response to determining that a pair of companion electronic devices in communication with the communication device are delivering audio content to a user while the pair of companion electronic devices operate in a noise cancelation mode of operation, determine that the user is speaking to an environment of the electronic device.

In one or more embodiments, the one or more processors further determine whether words spoken by the user are directed to at least one companion electronic device or to an object situated within the environment. When the words spoken by the user are directed to the object situated within the environment, the one or more processors deliver other signals to the pair of companion electronic devices causing the pair of companion electronic devices to transition from a noise canceling mode of operation to a transparency mode of operation.

Advantageously, by determining that a pair of companion electronic devices are delivering audio content to a user while operating in a noise cancelation mode, the system can accurately identify when the user is immersed in audio playback. This ensures that subsequent actions are contextually relevant to the user's current state, enhancing the overall user experience.

Determining that the user is speaking to the environment of the electronic device allows the system to recognize when the user is attempting to engage in an external conversation. This detection is beneficial for dynamically managing the audio settings, as it provides the necessary trigger to adjust the audio output and noise cancelation modes.

By determining whether words spoken by the user are directed to at least one companion electronic device or to an object situated within the environment, the system can differentiate between conversations intended for the device and those directed towards external individuals. This distinction allows for appropriately adjusting the audio settings to match the user's intent.

When the words spoken by the user are directed to an object situated within the environment, delivering other signals to the pair of companion electronic devices to transition from a noise canceling mode of operation to a transparency mode of operation allows the user to hear ambient sounds and converse naturally without the need to manually toggle settings. This automatic adjustment reduces user effort and prevents potential embarrassment from speaking too loudly, thereby improving the usability and comfort of the wireless headset device

In one or more embodiments, a method involves determining, with a communication device paired with a companion electronic device pair, that the companion electronic device pair is delivering audio content to a user while operating in a noise canceling mode of operation. In one or more embodiments, the method further includes determining, from signals received by the communication device from one or both companion electronic devices of the companion electronic device pair, that the user is speaking while the companion electronic device pair is delivering the audio content to the user while operating in the noise canceling mode of operation.

In one or more embodiments, the method also includes affirming, by one or more processors, that words spoken by the user are not directed to either companion electronic device of the companion electronic device pair. In one or more embodiments, when the one or more processors affirm the words spoken by the user are not directed to either companion electronic device of the companion electronic device pair, the method includes causing, by the one or more processors by delivering other signals to the companion electronic device pair, the companion electronic device pair to transition from the noise canceling mode of operation to a transparency mode of operation.

Advantageously, by determining that the companion electronic device pair is delivering audio content to a user while operating in a noise canceling mode, the system can accurately identify when the user is immersed in audio playback. This ensures that subsequent actions are contextually relevant to the user's current state, enhancing the overall user experience.

Determining from signals received by the communication device that the user is speaking while the companion electronic device pair is delivering the audio content allows the system to recognize when the user is attempting to speak. This detection is beneficial for dynamically managing the audio settings, as it provides the necessary trigger to adjust the audio output and noise cancelation modes.

Affirming that the words spoken by the user are not directed to either companion electronic device of the companion electronic device pair enables the system to differentiate between conversations intended for the device and those directed towards external individuals. This distinction allows for appropriately adjusting the audio settings to match the user's intent.

When the words spoken by the user are not directed to either companion electronic device, causing the companion electronic device pair to transition from the noise canceling mode of operation to a transparency mode of operation allows the user to hear ambient sounds and converse naturally without the need to manually toggle settings. This automatic adjustment reduces user effort and prevents potential embarrassment from speaking too loudly, thereby improving the usability and comfort of the wireless headset device. Other advantages offered by embodiments of the disclosure will be described below. Still others will be obvious to those of ordinary skill in the art having the benefit of this disclosure.

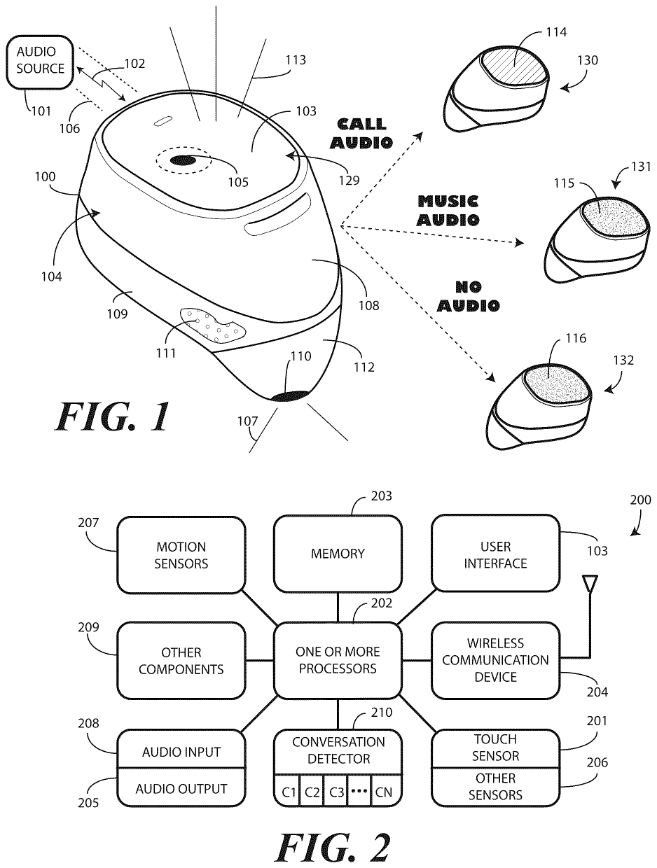

Turning now to FIG. 1, illustrated therein is one explanatory system in accordance with one or more embodiments of the disclosure. The system includes an audio source 101 and an electronic device 100, which is configured as one wireless ear bud of an electronic device pair in this illustrative example.

While one ear bud of the electronic device pair is shown, it should be noted that where the electronic device 100 is configured as an ear bud, it will frequently be sold and/or used as a pair. Accordingly, in one or more embodiments the electronic device 100 comprises a first ear bud and a second ear bud. However, only one electronic device 100 is shown in FIG. 1 for simplicity. While the electronic device 100 of FIG. 1 is configured as an ear bud, embodiments of the disclosure are applicable to any number of other communication devices that are operable with an audio source 101.

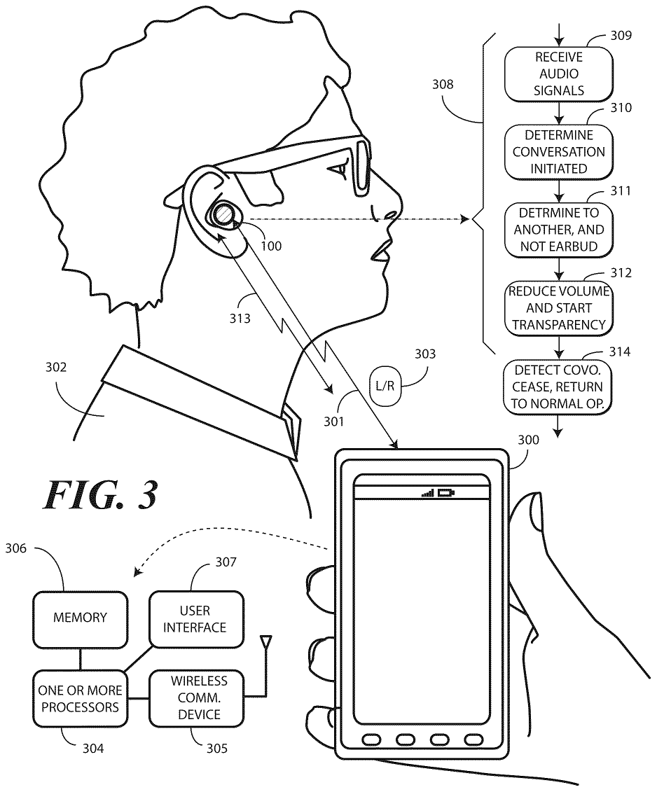

The audio source 101 can take any number of forms. Illustrating by example, in one explanatory embodiment used for illustrative purposes in FIGS. 3-6 below the audio source 101 comprises a companion electronic device configured as a smartphone that is in communication with the electronic device 100 via a local area, peer-to-peer network. However, it should be obvious to those of ordinary skill in the art having the benefit of this disclosure that other audio sources may be substituted for the explanatory smartphone of FIGS. 3-6.

For example, the audio source 101 could equally be a conventional desktop computer, palm-top computer, a tablet computer, a gaming device, a media player, or other device. In still other embodiments, the audio source 101 comprises a remote server or cloud server delivering electronic audio signals 102 to the electronic device 100 across a network. Accordingly, numerous other applications for embodiments of the disclosure will be obvious to those of ordinary skill in the art having the benefit of this disclosure.

In one or more embodiments, the electronic device 100 includes a touch-sensitive surface 103 that employs a control mapping along that touch-sensitive surface 103 to define one or more user interface actuators that allow a user to control the operation of the electronic device 100. In one embodiment the touch-sensitive surface 103 is configured as capacitive touch surfaces along a device housing 104 of the electronic device 100. However, in other embodiments a control mapping can be applied to a plurality of push buttons, slider switches, touch pads, rocker switches, or other devices.

In one or more embodiments, the touch-sensitive surface 103 may be able to use the control mapping to define one or more user actuation targets presented as virtual keys on a touch sensitive display. Still others can comprise voice commands delivered to a voice control interface. Even more others will be obvious to those of ordinary skill in the art having the benefit of this disclosure.

In one or more embodiments, the electronic device 100 is configured to establish a wireless communication channel 106 with an audio source 101. In one embodiment, where the audio source 101 comprises a locally paired device such as a smartphone, the wireless communication channel 106 comprise local area, ad-hoc, peer-to-peer communications using a protocol such as Bluetooth.sup.TM. Where the audio source 101 comprises a remote device, such as a cloud server in communication with the electronic device 100 across a network, other wide area protocols such as the transport protocol (TCP), the user datagram protocol (UDP), or another protocol can be used.

In this illustrative embodiment, the electronic device 100 receives electronic audio signals 102 from the audio source 101. The electronic audio signals 102 can be various types of audio signals. As shown in FIG. 1, the audio signals 120 can correspond to telephone calls, music, podcasts, other acoustic content, or even no audio whatsoever, such as when a user is using the electronic device 100 with an ANC mode of operation activated to, for example, concentrate on a pinball game in a crowded bar.

Illustrating by example, in one embodiment the electronic audio signals 102 comprise telephone call audio signals that are exchanged when the electronic device 100 is being used to communicate in a telephone call. In another embodiment, the electronic audio signals 102 comprise music audio signals, music playback audio signals, or music player audio signals that are exchanged when the electronic device 100 is being used to deliver acoustic audio signals 107 in the form of music to a user such as an MP3 recording of a song. Other examples of predefined types of audio signals received as electronic audio signals 102 from the audio source 101 will be obvious to those of ordinary skill in the art having the benefit of this disclosure.

It should be noted that stereo music content is only one example of multi-content information that can be delivered in accordance with one or more embodiments of the disclosure, as information other than channel content may be transmitted as well. Data content may be interlaced with other content, such as audio or video. For example, the content may include left channel audio, right channel audio, and data like call initiation, transfer, or drop requests. Other content or information suitable for use with embodiments of the disclosure will be obvious to those of ordinary skill in the art having the benefit of this disclosure.

In one or more embodiments, when the electronic audio signals 102 are received, they are delivered to a transducer such as a local loudspeaker or other audio output device. In one or more embodiments, one or more processors of the electronic device 100 are then operable to determine, from the electronic audio signals 102, an audio type of the electronic audio signals 102. For example, the one or more processors of the electronic device 100 may analyze the electronic audio signals 102, audio source information, including connection information for the audio source 101, and so forth to determine, for instance, whether the electronic audio signals 102 are telephone call audio signals, music audio signals, or another type of audio signals, e.g., white noise audio signals.

In one or more embodiments, the electronic device 100 is capable of placement in either the right or left ear. Where the electronic audio signals 102 comprise multi-channel audio, e.g., a left channel and a right channel, the electronic device 100 can be configured with an orientation device so as to determine which ear it is in and, accordingly, which channel to be play. Where included, the orientation device can determine a physical orientation so as to play the proper channel.

For example, if the electronic device 100 is one of an electronic device pair and is placed in the left ear, one or more control circuits of the electronic device 100 can select the left channel from the multi-channel audio information for delivery to its loudspeaker, and vice versa. One example of a suitable orientation device is an accelerometer, which can determine in which direction gravity is acting, and therefore in which ear each device is disposed. Where no orientation device is included, determining which wireless communication device plays the left channel or right channel can be user configurable. For example, a user may press a button, actuate a user interface actuator, deliver a voice command, and so forth.

The illustrative electronic device 100 of FIG. 1 includes an upper device housing 108 attached to a lower device housing 109. A circuit assembly is disposed within the electronic device 100, as well as a rechargeable battery, an acoustic driver, and other components.

In one or more embodiments, either the upper device housing 108 or the lower device housing 109 can define a microphone port to direct acoustic energy to one or more microphones of the circuit assembly. For example, such microphone ports can be disposed along the housing members to define acoustic beams along which acoustic energy is received. When the electronic device 100 is positioned in a user's ear, an acoustic beam can be directed toward the user's mouth so that the electronic device 100 can be used as a two-way communication device.

In the illustrative embodiment of FIG. 1, the lower device housing 109 defines an acoustic driver port 110. An acoustic driver can be positioned within the acoustic driver port 110. When the electronic device 100 is positioned within the user's ear, the acoustic driver can deliver acoustic audio signals 107 in the form of acoustic energy through the acoustic driver port 110 to the user's eardrum.

In one or more embodiments, the housing members are surrounded, or at least partially surrounded, by a soft, outer rubber layer 111. The soft, outer rubber layer 111, while optional, aids in user comfort by providing a soft surface against the contours of the user's ear. A cushion element 112 can be attached to the lower device housing 109 to provide an acoustic seal between a user's ear canal and the lower device housing 109. The cushion element 112 can be manufactured in varying sizes so that the electronic device 100 can be used in different sized ears.

In this illustrative embodiment, the upper surface of the electronic device 100 defines a touch-sensitive surface 103 disposed along the upper device housing 108 that can define a user interface actuator in accordance with a control mapping that defines the function and arrangement of the user interface actuators. As used herein, a “user interface actuator” is a user interface element that can be actuated by a user to cause one or more control circuits of the electronic device 100 to perform an action.

Examples of such actions include answering incoming calls, hanging up on ongoing calls, turning the volume of the acoustic driver situated within the acoustic driver port 110 up, turning the volume of the acoustic driver situated within the acoustic driver port 110 down, play the next song, pause the current song, skip to the previous song, actuate a voice assistant control function, or perform other functions. Of course, this list of functions is illustrative only, as numerous other will be obvious to those of ordinary skill in the art having the benefit of this disclosure.

In the illustrative embodiment of FIG. 1, the touch-sensitive surface 103 is defined by a capacitive touchpad formed by a flexible circuit substrate being placed beneath the upper surface of the upper device housing 108. The flexible circuit substrate includes a plurality of electrical conductors that define one or more electric field lines. It also includes a one or more light sources 105 that can project light through the upper surface of the upper device housing 108 to deliver a status indicator output or define user actuation targets. In one or more embodiments, when a user places a finger along the upper surface of the upper device housing 109, these electrical field lines change, thereby actuating the user actuation targets defined by the touch-sensitive surface 103.

As mentioned above, it should be noted that while the electronic device 100 is shown illustratively as an ear bud in FIG. 1, in other embodiments the electronic device 100 can be configured as other types of devices configured to deliver acoustic audio signals 107 to a user. Illustrating by example, in another embodiment the electronic device 100 is configured as a pair of headphones. In another embodiment, the electronic device 100 is configured as an earpiece. Still other devices will be obvious to those of ordinary skill in the art having the benefit of this disclosure.

Turning now to FIG. 2, illustrated therein is one explanatory block diagram schematic 200 of the explanatory electronic device (100) of FIG. 1. It should be understood that the block diagram schematic 200 of FIG. 2 is provided for illustrative purposes only and for illustrating components of one electronic device 100 in accordance with embodiments of the disclosure and is not intended to be a complete block diagram schematic 200 of the various components that can be included with the electronic device (100). Therefore, other electronic devices in accordance with embodiments of the disclosure may include various other components not shown in FIG. 2 or may include a combination of two or more components or a division of a particular component into two or more separate components, and still be within the scope of the present disclosure.

In one or more embodiments, the block diagram schematic 200 is configured as a printed circuit board assembly disposed within a device housing (104) of the electronic device 100. Various components can be electrically coupled together by conductors or a bus disposed along one or more printed circuit boards.

The illustrative block diagram schematic 200 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

As noted above with reference to FIG. 1, in one or more embodiments the electronic device (100) includes a touch-sensitive surface 103 defining a user interface. In the embodiment of FIG. 1, the user interface is configured as a touch-sensitive surface 103 through which a light source (105) could project light of different colors. However, in other embodiments the user interface could be configured in other ways as well.

Illustrating by example, in one or more embodiments the user interface is configured as a display positioned on the upper surface of the upper device housing (108). In one or more embodiments, the display comprises a touch sensitive display. Where so configured, information, graphical objects, user actuation targets, and other graphical indicia can be presented using the display. Regardless of whether the user interface is configured as a display or touch sensitive surface, in one or more embodiments, so as to be touch sensitive, the user interface comprises a touch-sensitive surface 103.

In one or more embodiments, the touch-sensitive surface 103 can comprise a touch sensor 201 that can be any of a capacitive touch sensor, an infrared touch sensor, resistive touch sensors, inductive touch sensing, another touch-sensitive technology, or combinations thereof. Capacitive touch-sensitive devices include a plurality of capacitive sensors, e.g., electrodes, which are disposed along a substrate. Where so configured, each capacitive sensor can be configured, in conjunction with associated control circuitry, e.g., the one or more processors 202, to detect an object in close proximity with—or touching—the surface of the display(s) by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Other technologies include metal mesh, silver nano wire, graphene, and carbon nanotubes. Further, it is capable of being deposited in thin layers by way of a printing process. The capacitive sensors may also be deposited on the substrate by electron beam evaporation, physical vapor deposition, or other various sputter deposition techniques.

In one or more embodiments, users can deliver user input to the user interface, be it a display or touch sensitive surface, by delivering touch input from a finger, stylus, or other objects disposed proximately with the user interface. Where the user interface is configured as a display, in one or more embodiments it is configured as an active matrix organic light emitting diode (AMOLED) display. However, it should be noted that other types of displays, including liquid crystal displays, are suitable for use with the user interface and would be obvious to those of ordinary skill in the art having the benefit of this disclosure.

In one embodiment, the electronic device (100) includes one or more processors 202. In one embodiment, the one or more processors 202 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the block diagram schematic 200. Each of the application processor and the auxiliary processor(s) can be configured to process and execute executable software code to perform the various functions of the electronic device (100) with which the block diagram schematic 200 operates. A storage device, such as memory 203, can optionally store the executable software code used by the one or more processors 202 during operation.

In this illustrative embodiment, the block diagram schematic 200 also includes a communication device 204 that can be configured for wired or wireless communication with one or more other devices or networks. The networks can include a wide area network, a local area network, and/or personal area network. The communication device 204 may also utilize wireless technology for communication, such as, but are not limited to, peer-to-peer or ad hoc communications such as HomeRF, Bluetooth and IEEE 802.11 and other forms of wireless communication such as infrared technology. The communication device 204 can include wireless communication circuitry, one of a receiver, a transmitter, or transceiver, and one or more antennas.

In one embodiment, the one or more processors 202 can be responsible for performing the primary functions of the electronic device with which the block diagram schematic 200 is operational. For example, in one embodiment the one or more processors 202 comprise one or more circuits operable with the user interface to present presentation information to a user. Additionally, the one or more processors 202 can be operable with an audio output 205 to deliver audio output to a user. The executable software code used by the one or more processors 202 can be configured as one or more modules that are operable with the one or more processors 202. Such modules can store instructions, control algorithms, and so forth.

Various sensors 206 can be operable with the one or more processors 202. In one or more embodiments, the other sensors 206 include one or more proximity sensors can be configured to detect objects proximately located with the user interface actuator or device housing (104) of the electronic device (100). The proximity sensors can fall into one of two camps: active proximity sensors that include a transmitter and receiver pair, and “passive” proximity sensors that include a receiver only. Either the proximity detector components or the proximity sensor components can be generally used for gesture control and other user interface protocols in one or more embodiments. Either the proximity detector components or the proximity sensor components can be generally used for distance determination, such as measuring distances between objects situated within the environment of the electronic device and/or determining changes in distance between the electronic device (100) and objects situated within the environment.

As used herein, a “proximity sensor component” comprises a signal receiver only that does not include a corresponding transmitter to emit signals for reflection off an object to the signal receiver. A signal receiver only can be used due to the fact that an external source, such as the body of a person or other heat-generating object external to the electronic device 100, can serve as the transmitter. Illustrating by example, in one embodiment the proximity sensor components comprise only a signal receiver to receive signals from objects external to the device housing (104) of the electronic device (100). In one embodiment, the signal receiver is an infrared signal receiver to receive an infrared emission from a source, such as a human being, when the human being is approaching or near the electronic device (100).

Proximity sensor components are sometimes referred to as “passive IR detectors” due to the fact that a person or other warm object serves as the active transmitter. Accordingly, the proximity sensor component requires no transmitter since objects disposed external to the housing deliver emissions that are received by the infrared receiver. As no transmitter is required, each proximity sensor component can operate at a very low power level.

In one embodiment, the signal receiver of each proximity sensor component can operate at various sensitivity levels so as to cause the at least one proximity sensor component to be operable to receive the infrared emissions from different distances. For example, the one or more processors 202 can cause each proximity sensor component to operate at a first “effective” sensitivity so as to receive infrared emissions from a first distance. Similarly, the one or more processors 202 can cause each proximity sensor component to operate at a second sensitivity, which is less than the first sensitivity, so as to receive infrared emissions from a second distance, which is less than the first distance. The sensitivity change can be effected by causing the one or more processors 202 to interpret readings from the proximity sensor component differently.

By contrast, “proximity detector components” include a signal emitter and a corresponding signal receiver, which constitute an “active” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers that define an active IR pair.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one or more embodiments the other sensors 206 include a skin sensor is configured to determine when the electronic device (100) is touching the skin of a person. For example, in one or more embodiments the skin sensor can determine when the electronic device (100) is placed within the ear of a user. In one embodiment, the skin sensor can include a substrate with an electrode disposed thereon. The electrode can confirm the object touching the skin sensor is skin by detecting electrical signals generated by a heartbeat in one embodiment. Other forms of skin sensors will be obvious to those of ordinary skill in the art having the benefit of this disclosure.

The other sensors 206 can include a light sensor. The light sensor can be used to detect whether or not direct light is incident on the device housing (104) of the electronic device 100 in one or more embodiments. The light sensor can also be used to detect an intensity of ambient light is above or below a predefined threshold in one or more embodiments. In one or more embodiments the light sensor can detect changes in optical intensity, color, light, or shadow in the near vicinity of the electronic device (100). The other sensors 206 can also include an audio input 208 in the form of one or more microphones that are operable to receive acoustic input. The other sensors 206 can also include a moisture sensor.

The electronic device 100 can include one or more motion sensors 207. The one or more motion sensors 207 can function as an orientation detector configured to determine a spatial orientation of the electronic device (100) in three-dimensional space. The one or more motion sensors 207 can include one or more accelerometers or gyroscopes. For example, an accelerometer may be embedded in the electronic circuitry of the electronic device (100) to show vertical orientation, constant tilt and/or whether the electronic device (100) is stationary. The measurement of tilt relative to gravity is referred to as “static acceleration,” while the measurement of motion and/or vibration is referred to as “dynamic acceleration.” A gyroscope can be used in a similar fashion.

In one or more embodiments, the one or more motion sensors 207 can detect motion of the electronic device (100). The one or more motion sensors 207 can be used to sense some of the gestures of a user as well. The one or more motion sensors 207 can be used to determine the spatial orientation of the electronic device (100) as well in three-dimensional space by detecting a gravitational direction. The one or more motion sensors 207 can also include an electronic compass to detect the spatial orientation of the electronic device (100) relative to the earth's magnetic field.

Other components 209 operable with the one or more processors 202 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as the one or more loudspeakers or other alarms and/or buzzers. The other components 209 can also include a mechanical output component such as vibrating or motion-based mechanisms.

In one or more embodiments, a conversation detector 210 is operable to determine that the user is speaking to an environment of the electronic device. In one or more embodiments, the conversation detector 210 is also operable to determine whether words spoken by the user are directed to at least one companion electronic device or to an object situated within the environment. This can occur in a variety of ways.

In one or more embodiments, the conversation detector 210 of FIG. 2 is a component within the electronic device in which the block diagram schematic 200 is operating that plays a role in managing the device's audio settings based on the user's speech. In one or more embodiments, the audio input 208, which includes one or more microphones, captures sounds from the environment. This includes the user's speech as well as other ambient noises.

In one or more embodiments, the conversation detector 210 receives these audio signals from the audio input 208. The conversation detector 210 then processes these signals to identify whether the captured sound is speech.

In one or more embodiments, once the conversation detector 210 identifies speech, the conversation detector 210 needs to determine the context of this speech. Specifically, the conversation detector 210 determines whether a user is speaking to the electronic device itself (e.g., giving a voice command or talking during a phone call) or to someone or something else in the environment (e.g., having a conversation with another person).

To accomplish this, in one or more embodiments the conversation detector 210 uses various algorithms and possibly additional sensor data. For example, the conversation detector 210 might analyze the content of the speech, the presence of other voices, or the user's gestures and head movements detected by other sensors in the device.

In one or more embodiments, based on this analysis, the conversation detector 210 instructs the electronic device to adjust the audio settings of the audio output 205 accordingly. If the user is speaking to the device, the device might maintain the current settings. If the user is speaking to someone else, the device might lower the volume and switch from noise cancelation mode to transparency mode, allowing the user to hear ambient sounds and converse naturally. In summary, the conversation detector 210 processes audio signals to determine the context of the user's speech and adjusts the device's audio settings to enhance the user's experience and avoid potential inconveniences or embarrassments.

In one or more embodiments, an electronic device containing the block diagram schematic 200 comprises a communication device 204 and one or more processors 202 operable with the communication device 204. In one or more embodiments, the one or more processors 202, in response to determining that the audio output 205 are delivering audio content to a user while the audio output 205 operates in a noise cancelation mode of operation, determine that the user is speaking to an environment of the electronic device using the conversation detector 210 as previously described.

In one or more embodiments, the one or more processors 202 further determine whether words spoken by the user are directed to the electronic device or to an object situated within the environment, one example of which might be a person. In one or more embodiments, when the words spoken by the user are directed to the object situated within the environment, the one or more processors 202 cause the audio output 205 to transition from a noise canceling mode of operation to a transparency mode of operation. In one or more embodiments, the one or more processors 202 also cause the audio output 205 to reduce a volume level of the audio content.

In one or more embodiments, the one or more processors 202 use the conversation detector 210 to determine that the user is speaking to the environment of the electronic device when the conversation detector 210 receives signals from the audio input 208. In response to additional signals received from the audio input 208 indicating a cessation of the user speaking to the environment, the one or more processors 202 can cause the audio output 205 to transition from the transparency mode of operation to the noise canceling mode of operation. In one or more embodiments, the one or more processors 202 can cause the audio output 205 to transition from the transparency mode of operation to the noise canceling mode of operation when a predefined gesture input has been received by the user interface as well.

Turning back to FIG. 1, in this illustrative embodiment the touch-sensitive surface 103 and light source 105 work in tandem to provide status indicator output 113 through the surface of the user interface actuator. In one or more embodiments, the status indicator output 113 presents one of multiple colors along the surface of the touch-sensitive surface 103. In one or more embodiments, the colors comprise green, yellow, and red.

These three colors are illustrative only, as other colors will be obvious to those of ordinary skill in the art having the benefit of this disclosure. Moreover, while three colors are used herein as an explanatory color set, in other embodiments the status indicator will employ fewer than three colors. In still other embodiments, the status indicator will employ more than three colors.

In another embodiment an electronic device can include one or more indicator bands configured as a status indicator for presenting the status of an authorized user of the electronic device to third parties. Such indicator bands can be positioned at various locations around the device housing. The indicator bands can comprise a semi-rigid polymer light pipe positioned above one or more light sources. The semi-rigid polymer light pipe can be manufactured from silicone, for example.

The semi-rigid polymer light pipe can comprise a continuous band disposed along the device housing. Alternatively, the semi-rigid polymer light pipe can be manufactured as one or more linear or non-linear strips, one or more interlaced linear or non-linear strips, a matrix of linear or non-linear strips, or in other configurations.

The semi-rigid polymer light pipe can contours matching those of the electronic device. At least a portion of the semi-rigid polymer light pipe can extend distally beyond the surface of the device housing so as to more readily be seen. This results in a distal edge of the semi-rigid polymer light pipe being raised above the surface of the device housing.

In another embodiment an electronic device can includes one or more displays positioned along the device housing. In one or more embodiments, these one or more displays allow for the projection of color, text, or other visual indicia from the sides of the electronic device so that those colors, text, or visual indicia can be seen by third parties. Other examples of configurations of status indicators will be obvious to those of ordinary skill in the art having the benefit of this disclosure.

In the illustrative embodiment of FIG. 1, the electronic device 100 is shown with the status indicator in four different states 129,130,131,132. In a first state 129, the status indicator is inactive. In a second state 130, the status indicator produces status indicator output 113 in the form of red light. In a third state 131, the status indicator produces status indicator output 113 in the form of yellow light. In a fourth state 132, the status indicator presents status indicator output 113 in the form of green light. In one or more embodiments, the status indicator comprises a visible output device presenting a predefined color of the three colors 114,115,116 to indicate a status of an authorized user of the electronic device 100.

Now that various hardware components have been described, attention will be turned to methods of using electronic devices in accordance with one or more embodiments of the disclosure. Turning now to FIGS. 3-7, illustrated therein are various methods in an electronic device in accordance with one or more embodiments of the disclosure. In one or more embodiments, the methods comprise determining, by one or more processors, that an audio output device of the electronic device is delivering audio content to a user while the electronic device is operating in a noise cancelation mode of operation.

In one or more embodiments, the method further includes determining, by the one or more processors from an audio input device of the electronic device, that the user is enunciating words. The method involves determining, by the one or more processors, whether the words are directed to the audio input device of the electronic device or an environment of the electronic device. When the words are directed to the environment of the electronic device, the method includes causing, by the one or more processors, the electronic device to transition from the noise cancelation mode of operation to a transparency mode of operation while lowering a volume level associated with the audio content. Additionally, when the words are directed to the audio input of the electronic device, the method includes maintaining operation of the electronic device in the noise cancelation mode of operation.

Beginning with FIG. 3, illustrated therein is the system of FIG. 1 in operation in accordance with one or more steps of a method 308. As shown, an authorized user 302 of the electronic device 100 is using the system. The authorized user 302 of the electronic device has positioned the electronic device 100 in their right ear, with a second electronic device disposed in the left ear (not shown).

The authorized user 302 is holding the audio source (101) in their hand. Here, the audio source (101) is a companion electronic device 300 configured as a smartphone. The audio source (101) could take other forms. Illustrating by example, the audio source (101) could be configured as a digital audio player, such as a MP3 player. Alternatively, the audio source (101) may be a personal computer or other portable computing device. The audio source (101) could be a streaming server in communication with the electronic device 100 across a network as well.

In this illustrative embodiment, the audio source (101) comprises a companion electronic device 300 configured as a smartphone capable of both making telephone calls and storing and playing music and multimedia content comprising music. As shown, an electronic device 100 is receiving, at step 309 of the method 308 with a communication device (204) audio signals 301 comprising audio content 303 from a companion electronic device 300.

One or more processors of the electronic device 100 can determine that the audio output device of the electronic device 100 is delivering this audio content 303 to the authorized user 302. In this illustrative embodiment, the audio output device can deliver the audio content to the authorized user 302 while operating in a noise cancelation mode of operation.

In this illustrative embodiment, the electronic device 100 positioned in the authorized user's right ear and the other electronic device positioned within the left ear (not shown) are truly wireless stereo (TWS) earbuds. TWS earbuds are a type of wireless earphones that do not have any physical wires connecting the left and right earpieces. Instead, a source device, one example of which is companion electronic device 300, transmits a wireless left channel to the left earbud and a to the right earbud. Functioning in this manner, the electronic device pair of earbuds offer a completely wireless audio experience, allowing users to enjoy music, make phone calls, and interact with their devices without the need for cables. This is especially true when the audio content 303 is delivered to the authorized user 302 while the electronic devices operate in a noise cancelation mode of operation.

TWS earbuds typically connect to a device, such as the smartphone defined by companion electronic device 300, a tablet, or a computer, via a near-field communication protocol such as Bluetooth.sup.TM. In one or more embodiments, each earbud contains a battery, speaker, microphone, and control sensors, enabling independent operation. This means the authorized user 302 can use both earbuds together for a stereo sound experience or use just one earbud in a “mono mode” for situational awareness or when the other earbud is not available.

These earbuds often feature touch-sensitive surfaces or sensors that allow users to control various functions through simple gestures. Common gestures include tapping, double-tapping, or holding the earbud to perform actions such as play/pause music, adjust volume, answer or end calls, and activate voice assistants.

TWS earbuds are popular for their convenience, portability, and ease of use. They are widely used for listening to music, making hands-free calls, and accessing voice assistants like Siri.sup.TM or Google.sup.TM Assistant. The absence of wires makes them ideal for activities such as exercising, commuting, and multitasking, providing users with a seamless and enjoyable audio experience.

In one or more embodiments, the companion electronic device 300 includes a communication device 305 and one or more processors 304 operable with the communication device 305. In one or more embodiments, the communication device 305 facilitates interaction between the one or more processors 304 and the earbuds defining a companion electronic device pair, thereby ensuring seamless communication and control.

The communication device 305 may utilize wireless technology for communication, such as peer-to-peer or ad hoc communications like Bluetooth, IEEE 802.11, or other forms of wireless communication. The communication device 305 includes wireless communication circuitry, one of a receiver, a transmitter, or transceiver, and one or more antennas.

The one or more processors 304 are responsible for performing the primary functions of the companion electronic device 300. The one or more processors 304 can include an application processor and, optionally, one or more auxiliary processors. The application processor and the auxiliary processor(s) can be a microprocessor, a group of processing components, one or more ASICs, programmable logic, or other types of processing devices.

In one or more embodiments, the one or more processors 304 can execute instructions to determine a pair of companion electronic devices, which in this example are earbuds, are in communication with the communication device 305 are delivering audio content 303 to a user while the pair of companion electronic devices operate in a noise cancelation mode of operation. In one or more embodiments, when this occurs the one or more processors 304 can execute various operational actions.

Illustrating by example, in one or more embodiments the one or more processors 304 can determine, at step 310, that the authorized user 302 is speaking to an environment of the electronic device. At step 311, the one or more processors 304 can determine at step 311 whether words spoken by the authorized user 302 are directed to at least one companion electronic device, e.g., electronic device 100, or to an object situated within the environment, such as a person.

In one or more embodiments, when the words spoken by the authorized user 302 are directed to the object situated within the environment, the one or more processors 304 can cause the communication device 305 to deliver other signals 313 to the pair of companion electronic devices causing, at step 312, the pair of companion electronic devices to transition from a noise canceling mode of operation to a transparency mode of operation.

In one or more embodiments, the other signals 313 further cause the pair of companion electronic devices to reduce a volume level of the audio content at step 312. In one or more embodiments, the one or more processors 304 determine that the authorized user 302 is speaking to the environment of the electronic device from signals received from at least one companion electronic device of the pair of companion electronic devices. Thus, while the electronic device 100 in the right ear and the other electronic device in the left ear may be TWS earbuds, in one or more embodiments the one or more processors 304 determine that the authorized user 302 is speaking to the environment of the electronic device from signals received from only the electronic device 100, or only from the other electronic device, and so forth.

In one or more embodiments, in response to additional signals received from the at least one companion electronic device of the pair of companion electronic devices indicating a cessation of the authorized user speaking to the environment at step 314, the one or more processors 304 cause the pair of companion electronic devices to transition from the transparency mode of operation to the noise canceling mode of operation at step 314. As noted above, in one or more embodiments the additional signals received at step 314 indicate that a predefined gesture input has been received by the at least one companion electronic device of the pair of companion electronic devices. Thus, the authorized user 302 may tap the user interface of the electronic device 100 to cause the operations of step 314 to occur to transition from the transparency mode of operation to the noise canceling mode of operation.

In one or more embodiments, the memory 306 of the companion electronic device 300 stores executable software code and data necessary for the operation of the device. The memory 306 works in conjunction with the one or more processors 304 to execute instructions that control the various functionalities of the companion electronic device 300. This includes, in some embodiments, determining, with the communication device paired with a companion electronic device pair (electronic device 100 in the right ear and the other electronic device in the left ear, for example), that the companion electronic device pair is delivering audio content 303 to the authorized user 302 while operating in a noise canceling mode of operation. In one or more embodiments, this comprises determining, from signals received by the communication device 305 from one or both companion electronic devices of the companion electronic device pair, that the authorized user 302 is speaking while the companion electronic device pair is delivering the audio content 303 to the user while operating in the noise canceling mode of operation.

In one or more embodiments, the one or more processors 304 affirm that words spoken by the authorized user 302 are not directed to either companion electronic device of the companion electronic device pair. In one or more embodiments, when the one or more processors 304 affirm the words spoken by the authorized user 302 are not directed to the either companion electronic device of the companion electronic device pair, the one or more processors 304 cause, by delivering other signals 313 to the companion electronic device pair, the companion electronic device pair to transition from the noise canceling mode of operation to a transparency mode of operation.

The user interface 307 of the companion electronic device 300 provides an interface for the authorized user 302 to interact with the companion electronic device 300 through touch or gesture-based inputs. The user interface 307 can include a touch-sensitive surface that detects user gestures such as taps, swipes, and holds. The user interface 307 ensures that users can easily and intuitively control the device's functionalities, enhancing the overall user experience by providing seamless and responsive interaction.

While the companion electronic device 300 can perform the operations of the method 308 in one or more embodiments, in other embodiments the one or more processors (202) of the electronic device 100 in the right ear, the electronic device in the left ear, or both, can also perform the operations of the method 308 independently of the companion electronic device 300.

Illustrating by example, in one or more embodiments the one or more processors (202) of electronic device 100 can determine that an audio output device (205) of the electronic device 100 is delivering audio content 303 to the authorized user 302 while the electronic device 100 is operating in a noise cancelation mode of operation. In one or more embodiments, the one or more processors (202) determine from an audio input device (208) of the electronic device 100, that the authorized user 302 is enunciating words. An example of this operation is shown at step 310 of the method 308.

In one or more embodiments, the one or more processors (202) determine whether the words are directed to the audio input device (208) of the electronic device 100 or an environment of the electronic device 100. In one or more embodiments, when the words are directed to the environment of the electronic device 100, the one or more processors (202) cause the electronic device 100 to transition from the noise cancelation mode of operation to a transparency mode of operation while lowering a volume level associated with the audio content. An example of this operation is shown at step 312 of the method 308.

Advantageously, this transition allows the authorized user 302 to hear ambient sounds, facilitating natural conversations without the need to manually toggle between modes. For instance, if the authorized user 302 is listening to music with active noise cancelation (ANC) enabled and someone approaches to ask a question, the system will automatically switch to transparency mode and lower the volume. This enables the authorized user 302 to hear the question clearly and respond appropriately, enhancing situational awareness and reducing the likelihood of speaking too loudly due to the lack of environmental feedback.

In one or more embodiments, when the words are directed to the audio input (208) of the electronic device 100, the one or more processors (202) maintain operation of the electronic device in the noise cancelation mode of operation. Maintaining operation of the electronic device 100 in the noise cancelation mode of operation when the words are directed to the audio input (208) of the electronic device 100 is also beneficial.

Illustrating by example, this ensures that the authorized user 302 continues to benefit from the immersive audio experience during device interactions, such as voice commands or phone calls. For example, if the authorized user 302 is on a phone call while using ANC-enabled earbuds, the system will maintain the noise cancelation mode, allowing the user to focus on the conversation without being distracted by ambient noise. This selective adjustment of audio settings based on the context of the conversation enhances the functionality and user experience of the electronic device 100.

In another use case, consider a user commuting on a noisy train while listening to a podcast. If the user needs to ask a fellow passenger for directions, the system will detect the user's speech directed towards the environment and switch to transparency mode, lowering the podcast volume. This allows the user to hear the passenger's response clearly. Conversely, if the user receives a phone call during the commute, the system will maintain the noise cancelation mode, ensuring that the user can hear the caller without the interference of train noise. This dynamic management of audio settings provides a seamless and intuitive user experience, adapting to the user's needs in real-time.

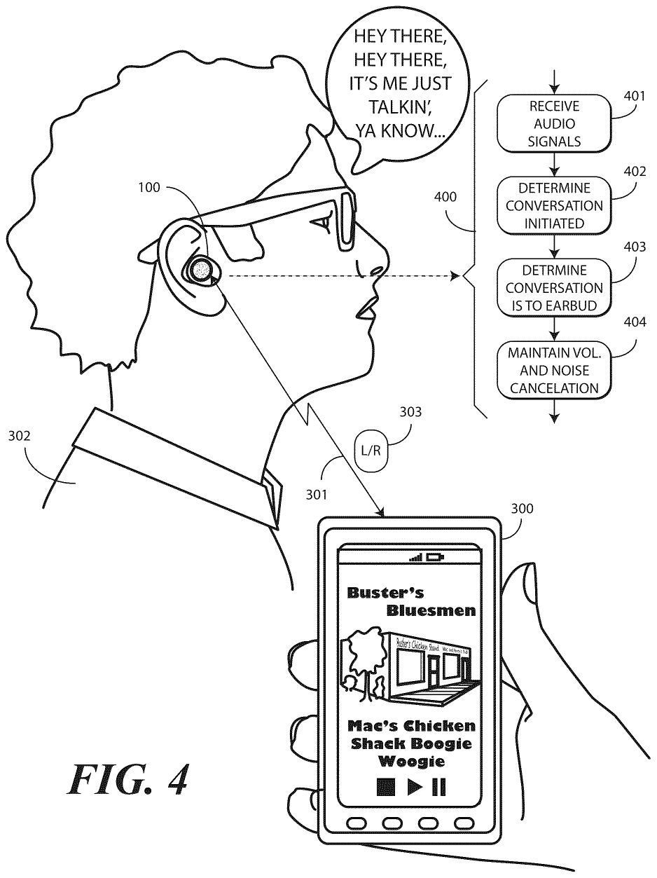

Now that the general method 308, which can be performed by the one or more processors 304 of companion electronic device 300 or by the one or more processors (202) of the electronic device 100, are understood, it is well to turn to some use cases to further illustrate embodiments of the disclosure. Turning now to FIG. 4, as illustrated therein the authorized user 302 of the electronic device 100 has configured the companion electronic device 300 as a music player, with the track, “Mac's Chicken Shack Boogie Woogie,” by the renowned artist Buster and his Bluesmen, defining the audio content 303 being delivered to the authorized user 302 by the electronic device 100 while the electronic device 100 operates in a noise canceling mode of operation. Album cover art of this sensational tune is presented on a display of the companion electronic device 300.

As shown in FIG. 4, audio signals 301 are music audio signals delivering audio content 303 in the form of music since the companion electronic device 300 is operating in a music player mode. The audio signals 301 comprise electronic audio signals of the song being played, namely, Mac's Chicken Shack Boogie Woogie by the infamous Buster and his Bluesmen.

As connoisseurs of Buster's music will readily understand, the lyrics of Mac's Chicken Shack Boogie Woogie are as follows:
Verse 1: Down at Mac's Chicken Shack, where the boogie's at, the rhythm's hot and the groove is fat. Buster's guitar sings the blues, with a rhythm you can't refuse, come on down, let's dance the night away, no time to lose.
Chorus: Hey there, hey there, it's me just talking, you know, let's hit the floor, let's put on a show. Swing those hips, let the good times flow, at Mac's Chicken Shack, where the boogie woogie grows.
Verse 2 (inspired by Buster's other business, his Tofu Shack): Crispy tofu bites, seasoned just right, tofu tacos, a flavor delight. Tofu stir-fry, veggies so bright, at Mac's Chicken Shack, we're groovin' all night.
Bridge: Tofu curry, tofu salad, tofu soup so grand, tofu skewers, the best in the land. Mac's got the flavors, the music, the band, come on down, let's dance hand in hand.
Outro: So, if you're feeling down, and you need a lift, Mac's Chicken Shack is the perfect gift. With Buster's blues and a tofu twist, we'll dance all night, you won't want to miss.

As set forth above, the chorus to this majestic opus, which is sung between every verse, before and after the bridge, and after the outro, states, “Hey there, hey there, it's me just talking, you know, let's hit the floor, let's put on a show.” As shown in FIG. 4, the authorized user 302 of electronic device 100 starts to sing with the song. After all, the lyrics are just so catchy.

In the method 400 of FIG. 4, one or more processors of the electronic device 100 determine at step 401 that an audio output device of the electronic device 100 is delivering audio content 303 to the authorized user 302. In this illustrative embodiment, the electronic device 100 is operating in a noise cancelation mode of operation. Accordingly, the one or more processors of the electronic device 100 determine that an audio output device of the electronic device 100 is delivering audio content 303 to the authorized user 302 while the electronic device 100 is operating in the noise canceling mode of operation. After all, the authorized user 302 wants to immerse himself in the stylings of Buster and each and every one of the Bluesmen contributing to the harmonious mix.

At step 402, the one or more processors of electronic device 100 determine from an audio input device of the electronic device 100, that the user is enunciating words. In this illustrative example, authorized user 302 is singing lyrics to the song.

At step 403, the one or more processors of electronic device 100 determine whether the words are directed to the audio input device of the electronic device 100 or an environment of the electronic device. In this example, they are directed to the electronic device 100. The one or more processors determine this by comparing the enunciated words to the audio content 303. In this illustrative example, the processors identify that the words are lyrics to the song defined by the audio content 303.

Several techniques can be employed to accomplish this comparison, each with a set of advantages. In a first embodiment, real-time speech recognition and matching are used. In such a technique, the processors of electronic device 100 use real-time speech recognition to convert the enunciated words into text. This text is then compared to the lyrics of the song being played. Advantages of this technique include high accuracy in identifying exact matches between spoken words and song lyrics. immediate determination and response, and contextual awareness. To wit, the one or more processors can handle variations in pronunciation and accent, improving reliability.

In another embodiment, phonetic matching can be used. Illustrating by example, the processors convert both the enunciated words and the audio content into phonetic representations. These phonetic sequences are then compared to identify matches. The advantages of this technique include that it is effective in noisy environments where exact word matching may fail. It is also flexible in that it can handle different pronunciations and accents more effectively than direct text matching.

In still another embodiment, audio signal analysis can be used. The processors can analyze the audio signals of both the enunciated words and the song. By comparing the frequency and amplitude patterns, the system can determine if the spoken words match the song lyrics. The advantages of this technique include that it does not rely on language processing, making the system useful for songs in different languages. Moreover, signals can be processed in real-time, providing immediate feedback.

In still other embodiments, machine learning models can be used. To wit, the processors can use pre-trained machine learning models to recognize patterns in the enunciated words and compare them to the song lyrics. These models can be trained on large datasets of song lyrics and spoken words. Advantages of this technique include that it can improve over time with more data, increasing accuracy. Moreover, it can understand context and nuances in speech, improving matching accuracy.

Thus, the advantages of each technique for determining whether the enunciated words are directed to the earbud, or the environment are as follows: Real-Time Speech Recognition and Matching provides high accuracy and immediate response, making the system suitable for dynamic environments. It can handle variations in pronunciation and accent, ensuring reliable performance.

Phonetic Matching offers robustness in noisy environments where exact word matching may fail. It is flexible in handling different pronunciations and accents, enhancing the user experience. Audio Signal Analysis is effective for non-linguistic matching, making the system versatile for songs in different languages. Its real-time processing ensures immediate feedback, improving usability.

Machine Learning Models are adaptable and can improve over time with more data, increasing overall accuracy. They provide contextual understanding, enhancing the system's ability to match spoken words to song lyrics accurately. By employing these techniques, the electronic device 100 can accurately determine whether the enunciated words are directed to the earbud or the environment, ensuring seamless transitions between noise cancelation and transparency modes, thereby enhancing the overall user experience.

Other techniques will be obvious to those of ordinary skill in the art having the benefit of this disclosure. By employing these techniques, the electronic device 100 can accurately determine whether the enunciated words are directed to the earbud or the environment, ensuring seamless transitions between noise cancelation and transparency modes, thereby enhancing the overall user experience.

In this example, since the words are directed to the audio input of the electronic device 100, the one or more processors maintain operation of the electronic device 100 in the noise cancelation mode of operation at step 404. Thus, in the example of FIG. 4 the determining, at step 403, whether the words detected at step 402 are directed to the audio input device of the electronic device 100 or the environment of the electronic device 100 comprises determining the words are directed to the audio input device of the electronic device 100 when the words define enunciations corresponding to the audio content 303. More specifically, in this illustrative example, the audio content 303 comprises music and the determining, at step 403, whether the words detected at step 402 are directed to the audio input device of the electronic device 100 or the environment of the electronic device 100 comprises determining the words are directed to the audio input device of the electronic device when the words define lyrics to the music.

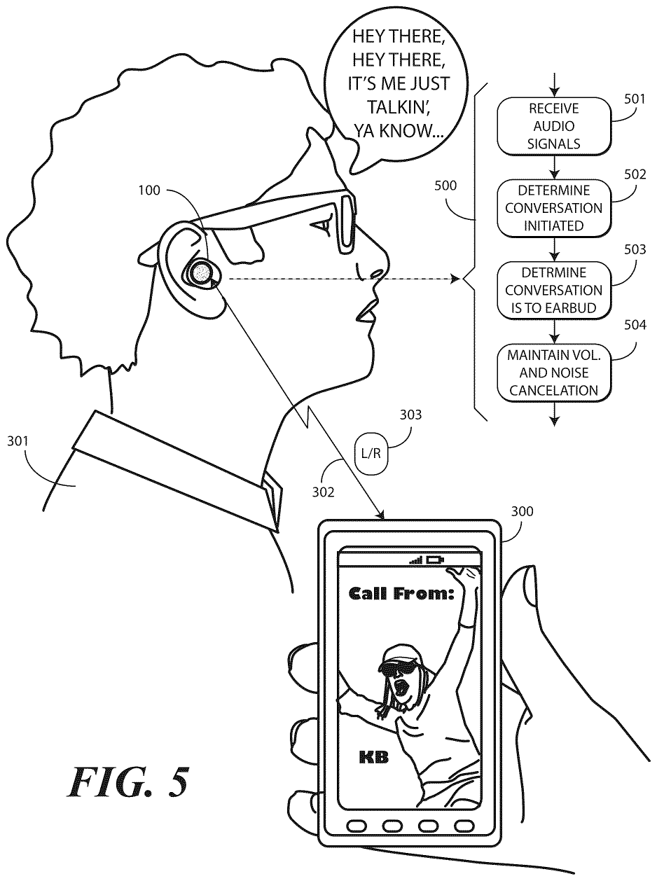

Turning now to FIG. 5, illustrated therein is another use case illustrating further features offered by embodiments of the disclosure. In FIG. 5, while the authorized user 302 of electronic device 100 is jamming to the soulful sounds of Mac's Chicken Shack Boogie Woogie, the companion electronic device 300 receives a call from KB. This call interrupts the enjoyment of the music.

The companion electronic device 300, configured as a smartphone, detects the incoming call and subsequently delivers audio signals 301 containing audio content 303 in the form of the phone call to the electronic device 100. The electronic device 100, operating in a noise cancelation mode, receives these audio signals 301 and transitions to handle the phone call.

Upon receiving the call, the one or more processors of the electronic device 100 determine that the audio output device is now delivering audio content 303 in the form of a phone call at step 501. Once again, the authorized user 302 emits words in the form of “Hey there, hey there, it's just me talking, you know. . . . ” The audio input device of electronic device 100 detects these words at step 502 of the method 500.

At step 503, the one or more processors of electronic device 100 determine whether the words are directed to the audio input device of the electronic device 100 or an environment of the electronic device. In this example, the one or more processors again determine that the words are directed to the audio input of electronic device 100. This is true because the determining occurring at step 503 of whether the words are directed to the audio input device of the electronic device 100 or the environment of the electronic device 100 comprises determining the words are directed to the audio input device of the electronic device 100 when an application operating on the companion electronic device 300 actively in communication with the electronic device 100 is utilizing the audio input device.

Since the authorized user 302 is speaking to KB using the audio input device, the telephone application operating on companion electronic device 300 is utilizing the audio input device, thereby causing the one or more processors to conclude that the words are directed for electronic device 100. However, step 503 can be determined in other ways as well.

In other embodiments, the determining whether the words are directed to the audio input device of the electronic device 100 or the environment of the electronic device 100 comprises determining the words are directed to the audio input device of the electronic device 100 when the words define enunciations corresponding to the audio content 303. Since the audio content 303 is a phone call in this example, these enunciations correspond to the audio content 303 due to the fact that the enunciations define responses to calls defined by the audio content 303. Indeed, the authorized user 302 is speaking in responses to calls defined by KB's words contained in the audio content 303. Thus, the one or more processors determine at step 503 that the phrase is directed to electronic device 100.

The enunciations can correspond to the audio content when the enunciations define exclamations in response to portions of the audio content 303. Thus, if the authorized user 302 gets really mad at KB and screams at her in response to the names she's so rudely calling him, these exclamations in response to portions of the audio content 303 can indicate that the words detected are directed to electronic device 100 and not the environment.

In this example, since the words are directed to the audio input of the electronic device 100, the one or more processors maintain operation of the electronic device 100 in the noise cancelation mode of operation at step 504. Accordingly, the system of FIG. 5 dynamically manages the transition from music playback to phone call mode, ensuring that the authorized user 302 can answer the call promptly. The electronic device 100 maintains the noise cancelation mode during the phone call at step 504 to provide a clear and immersive audio experience, allowing the authorized user 302 to focus on the conversation without being distracted by ambient noise. This seamless transition ensures that the authorized user 302 can answer the call from KB without missing important details or facing potential scolding.

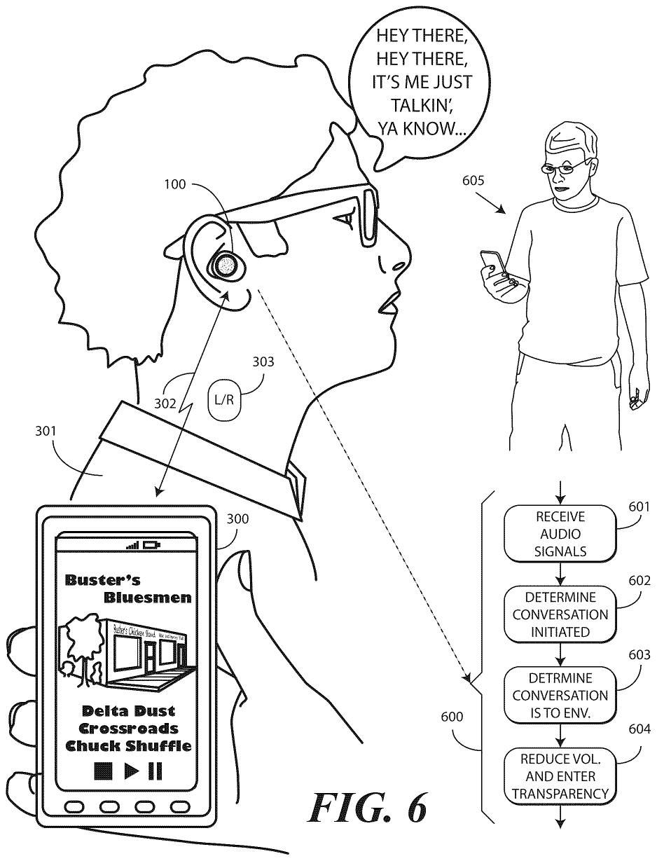

Turning now to FIG. 6, illustrated therein is yet another use case illustrating further features offered by embodiments of the disclosure. As shown in FIG. 6, the authorized user 302 has wrapped his call with KB, thereby allowing the sultry sounds of Buster and his Bluesmen to again deliver aural bliss through electronic device 100, which again operates in a noise canceling mode of operation.

The song has now advanced from Mac's Chicken Shack Boogie Woogie to Delta Dust Crossroads Chuck Shuffle, another favorite of the authorized user 302. The authorized user 302 appreciates Delta Dust Crossroads Chuck Shuffle for the intricate guitar riffs, which showcase Buster's skill and creativity. The song's rhythm section, featuring a tight bassline and dynamic drumming, provides a solid foundation that drives the track forward, creating an engaging and immersive listening experience.

Additionally, the authorized user 302 enjoys the song's lyrical content, which tells a story of a journey through the crossroads with his trusty dog, Chuck, with said journey filled with vivid imagery and emotional depth. The harmonica solos interspersed throughout the track add a layer of authenticity and raw emotion, further enhancing the song's appeal. The seamless transitions between different musical sections in Delta Dust Crossroads Chuck Shuffle demonstrate the band's versatility and cohesion, making Delta Dust Crossroads Chuck Shuffle a standout piece in Buster and his Bluesmen's repertoire. The authorized user 302 finds the combination of these elements to be particularly captivating, making Delta Dust Crossroads Chuck Shuffle a cherished addition to his playlist.

As shown, the companion electronic device 300 delivers this song in the form of audio signals 301 containing audio content 303. These audio signals 301 are received at step 601 of the method 600 shown in FIG. 6.

In the illustrative embodiment of FIG. 6, a person 605 other than the authorized user 302 is present in the environment. The authorized user 302, while listening to audio content 303 through the electronic device 100 while operating in a noise cancelation mode, decides to initiate a conversation with the other person 605. To gain the attention of the other person 605, who is initially engrossed in an activity on a smartphone, the authorized user 302 states, “Hey there, hey there, just me talking, you know. . . . ”

Upon detecting the authorized user 302 enunciating words at step 602, the electronic device 100 utilizes the audio input device to capture the speech. The one or more processors of the electronic device 100 then determine whether the words are directed towards the audio input device of the electronic device 100 or the environment.

In this scenario, the processors identify that the words are directed towards the environment, specifically to the other person 605. This occurs despite the fact that the words are exactly the same as those enunciated in FIGS. 4-5.

In one or more embodiments, the one or more processors make this distinction because the words are wholly unrelated to the audio content 303. In one or more embodiments, at step 603 of FIG. 6, one or more processors can conclude that the words spoken by the authorized user 302 are not directed to electronic device 100 because they are wholly unrelated to the audio content 303. The processors can achieve this by analyzing the context and content of the spoken words in relation to the audio content 303 being delivered. The processors can utilize algorithms to compare the spoken words with the audio content 303, which in this case is the song “Delta Dust Crossroads Chuck Shuffle” by Buster and his Bluesmen. The processors identify that the spoken words do not match any lyrics, phrases, or contextual elements of the song.

The processors can employ real-time speech recognition to convert the spoken words into text and then compare this text with the lyrics of the song. Since the spoken words do not correspond to any part of the song's lyrics, the processors determine that the words are unrelated to the audio content 303. Additionally, the processors may use phonetic matching to convert both the spoken words and the audio content into phonetic representations. By comparing these phonetic sequences, the processors can identify that the spoken words do not align with the phonetic patterns of the song's lyrics.

Furthermore, the processors can analyze the audio signals of both the spoken words and the song. By comparing the frequency and amplitude patterns, the processors determine that the spoken words do not match the song's audio signals. This analysis confirms that the spoken words are unrelated to the audio content 303. Machine learning models trained on large datasets of song lyrics and spoken words can also be used to recognize patterns and context, further validating that the spoken words are not directed to the electronic device 100.

By employing these techniques, the processors accurately conclude that the words spoken by the authorized user 302 are not directed to the electronic device 100 because they are wholly unrelated to the audio content 303. This determination allows the system to transition from the noise cancelation mode to the transparency mode, facilitating a natural conversation between the authorized user 302 and the other person 605 without the need for manual intervention.

In other embodiments, the determining whether the words are directed to the audio input device of the electronic device or the environment of the electronic device at step 603 comprises determining the words are directed to the environment when the audio input receives acoustic input from a person 605 other than the authorized user 302 within the environment. Thus, if the other person 605 said hello to the authorized user 302, as detected at step 602, the one or more processors can conclude the words enunciated by the authorized user 302 are directed to the environment.

In one or more embodiments, when the words are directed to the environment of the electronic device 100, the one or more processors cause the electronic device 100 at step 604 to transition from the noise cancelation mode of operation to a transparency mode of operation while lowering a volume level associated with the audio content 303. In one or more embodiments, the lowering of the volume level at step 604 comprises muting the volume level. In other embodiments, the lowering of the volume level at step 604 is achieved by pausing the delivering the audio content 303 to the authorized user 302 by the audio output device.

Thus, in one or more embodiments at step 604 the electronic device 100 transitions from the noise cancelation mode to a transparency mode, allowing ambient sounds to be heard. Simultaneously, the volume level of the audio content is lowered, facilitating a natural conversation between the authorized user 302 and the other person 605 without the need for manual intervention.

In one or more embodiments, the causing the electronic device 100 to transition from the noise cancelation mode of operation to the transparency mode of operation while lowering the volume level associated with the audio content 303 occurs only when the electronic device 100 is one electronic device of an electronic device pair and both electronic device of the electronic device pair are delivering the audio content to the user while operating in the noise cancelation mode of operation. Thus, in one or more embodiments step 604 only occurs when electronic device 100 is in the right ear and another electronic device is in the left ear while both are delivering the audio content 303 to the authorized user 302 in accordance with the method 600 at step 601 while operating in the noise canceling mode of operation.

In one or more embodiments, the method 600 can include an additional step. To wit, the method 600 can comprise also determining, by the one or more processors when the words are directed to the environment, that the authorized user 302 has ceased enunciating the words. In one or more embodiments, when this occurs, the method 600 comprises also causing, by the one or more processors, the electronic device 100 to transition from transparency mode of operation to the noise cancelation mode of operation while increasing the volume level associated with the audio content 303.

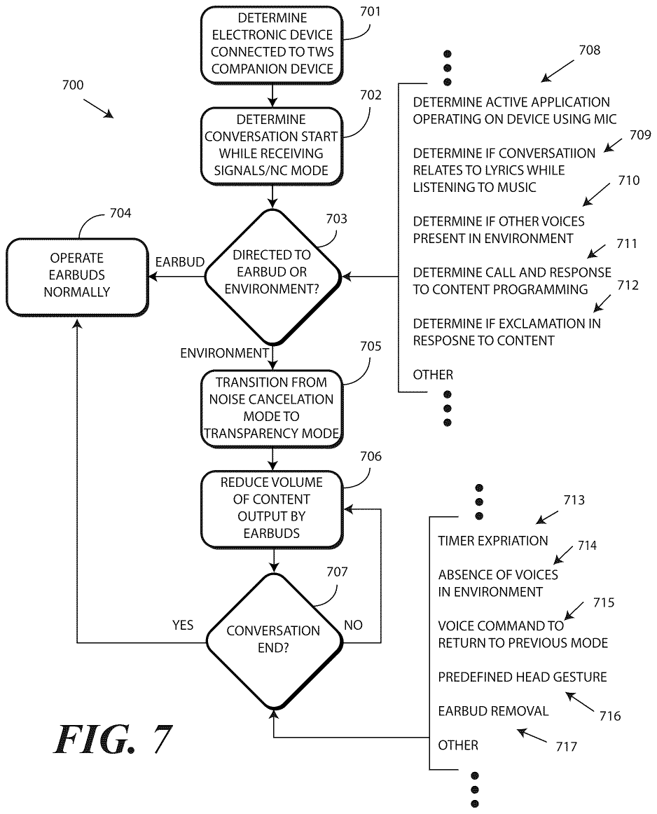

Turning now to FIG. 7, illustrated therein is one explanatory method 700 in accordance with one or more embodiments of the disclosure. Beginning with step 701, in one or more embodiments the method 700 determines, with a communication device paired with a companion electronic device pair, that the companion electronic device pair is delivering audio content to a user while operating in a noise canceling mode of operation.

At step 702, the method 700 determines, from signals received by the communication device from one or both companion electronic devices of the companion electronic device pair, that the user is speaking while the companion electronic device pair is delivering the audio content to the user while operating in the noise canceling mode of operation.

At decision 703, the method 700 affirms, using one or more processors, that words spoken by the user are not directed to either companion electronic device of the companion electronic device pair. This can be accomplished in a variety of ways.

In one or more embodiments, decision 703 determines whether the words are directed to the audio input device of the electronic device or the environment of the electronic device by determining the words are directed to the audio input device of the electronic device when an application 708 operating on a companion electronic device actively in communication with the electronic device is utilizing the audio input device. In other embodiments, such as when the audio content comprises music, the determining whether the words are directed to the audio input device of the electronic device or the environment of the electronic device at decision 703 comprises determining the words are directed to the audio input device of the electronic device when the words define lyrics to the music.

In still other embodiments, the determining whether the words are directed to the audio input device of the electronic device or the environment of the electronic device at decision 703 comprises determining the words are directed to the environment when the audio input receives acoustic input from a person 710 other than the user within the environment.

In still other embodiments, the determining whether the words are directed to the audio input device of the electronic device or the environment of the electronic device at decision 703 comprises determining the words are directed to the audio input device of the electronic device when the words define enunciations corresponding to the audio content. Illustrating by example, in one or more embodiments the enunciations correspond to the audio content when the enunciations define responses to calls 711 defined by the audio content. In other embodiments, the enunciations correspond to the audio content when the enunciations define exclamations 712 in response to portions of the audio content. Other ways of performing decision 703 will be obvious to those of ordinary skill in the art having the benefit of this disclosure.

In one or more embodiments, when the words are directed to the audio input of the electronic device, step 704 maintains operation of the electronic device in the noise cancelation mode of operation. By contrast, when the one or more processors affirm the words spoken by the user are not directed to the either companion electronic device of the companion electronic device pair, step 705 comprises causing, by the one or more processors by delivering other signals to the companion electronic device pair, the companion electronic device pair to transition from the noise canceling mode of operation to a transparency mode of operation.

In one or more embodiments, step 705 can comprise precluding delivery of the other signals when the audio content is being delivered by the communication device to the companion electronic device pair by an application operating on the one or more processors that is actively using an audio input device of the companion electronic device pair as an input. In one or more embodiments, step 705 can comprise precluding the delivery of the other signals when the audio content is a song and the words spoken by the user define lyrics to the song.

A step 706, the method 700 can comprise the other signals further causing the companion electronic device pair to lower a volume level of the audio content. In one or more embodiments, step 706 comprises muting the volume level. In other embodiments, step 706 is achieved by pausing the delivering the audio content to the user by the audio output device.

In one or more embodiments, decision 707 comprises also determining, by the one or more processors when the words are directed to the environment, that the user has ceased enunciating the words. This can be achieved in a variety of ways.

In one or more embodiments, when a cessation of words occurs, a timer 713 is actuated. In one or more embodiments, when the timer 713 expires, decision 707 comprises also determining, by the one or more processors when the words are directed to the environment, that the user has ceased enunciating the words.

In other embodiments, an absence of voices 714 can cause decision 707 to determine that the user has ceased enunciating the words. In still other embodiments, a user can deliver a voice command 714 to cause decision 707 to determine that the user has ceased enunciating the words. A predefined gesture, such as a head gesture 716 or removal 717 of an earbud from the ear, can also cause decision 707 to determine that the user has ceased enunciating the words. Other techniques for causing decision 707 to determine that the user has ceased enunciating the words will be obvious to those of ordinary skill in the art having the benefit of this disclosure.

In one or more embodiments, where decision 707 determines that the user has ceased enunciating the words, step 704 can comprise also causing, by the one or more processors, the electronic device to transition from transparency mode of operation to the noise cancelation mode of operation while increasing the volume level associated with the audio content.

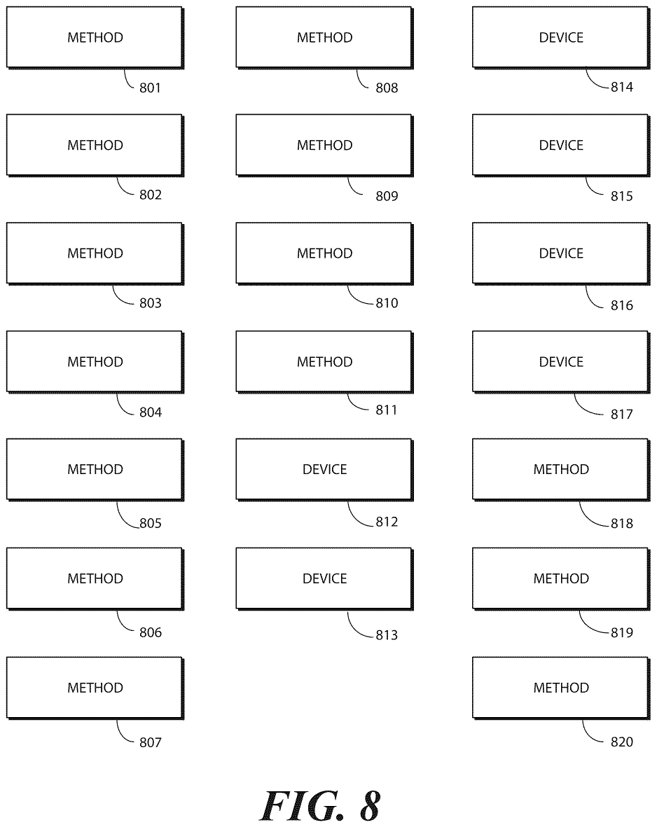

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. XX. Accordingly, since these items have previously been illustrated and described, their repeated illustration is no longer essential for a proper understanding of these embodiments. Thus, the embodiments are shown as labeled boxes.

At 801, a method in an electronic device comprises determining, by one or more processors, that an audio output device of the electronic device is delivering audio content to a user while the electronic device is operating in a noise cancelation mode of operation. At 801, the method comprises determining, by the one or more processors from an audio input device of the electronic device, that the user is enunciating words

At 801, the method comprises determining, by the one or more processors, whether the words are directed to the audio input device of the electronic device or an environment of the electronic device. At 801, when the words are directed to the environment of the electronic device, the method comprises causing, by the one or more processors, the electronic device to transition from the noise cancelation mode of operation to a transparency mode of operation while lowering a volume level associated with the audio content. At 801, when the words are directed to the audio input of the electronic device, the method comprises maintaining operation of the electronic device in the noise cancelation mode of operation.

At 802, the lowering of the volume level at 801 comprises muting the volume level. At 803, the lowering of the volume level at 801 is achieved by pausing the delivering the audio content to the user by the audio output device.

At 804, the causing the electronic device to transition from the noise cancelation mode of operation to the transparency mode of operation while lowering the volume level associated with the audio content of 801 occurs only when the electronic device is one electronic device of an electronic device pair and both electronic device of the electronic device pair are delivering the audio content to the user while operating in the noise cancelation mode of operation.

At 805, the determining whether the words are directed to the audio input device of the electronic device or the environment of the electronic device of 801 comprises determining the words are directed to the audio input device of the electronic device when an application operating on a companion electronic device actively in communication with the electronic device is utilizing the audio input device.

At 806, the audio content of 801 comprises music and the determining whether the words are directed to the audio input device of the electronic device, or the environment of the electronic device comprises determining the words are directed to the audio input device of the electronic device when the words define lyrics to the music.

At 807, the determining whether the words are directed to the audio input device of the electronic device or the environment of the electronic device of 801 comprises determining the words are directed to the audio input device of the electronic device when the words define enunciations corresponding to the audio content. At 808, the enunciations of 807 correspond to the audio content when the enunciations define responses to calls defined by the audio content. At 809, the enunciations of 807 correspond to the audio content when the enunciations define exclamations in response to portions of the audio content.

At 810, the determining whether the words are directed to the audio input device of the electronic device or the environment of the electronic device of 801 comprises determining the words are directed to the environment when the audio input receives acoustic input from a person other than the user within the environment.

At 811, the method of 801 further comprises also determining, by the one or more processors when the words are directed to the environment, that the user has ceased enunciating the words. At 811, the method comprises also causing, by the one or more processors, the electronic device to transition from transparency mode of operation to the noise cancelation mode of operation while increasing the volume level associated with the audio content.

At 812, an electronic device comprises a communication device and one or more processors operable with the communication device. At 812, the one or more processors, in response to determining pair of companion electronic devices are in communication with the communication device are delivering audio content to a user while the pair of companion electronic devices operate in a noise cancelation mode of operation, determine that the user is speaking to an environment of the electronic device.

At 812, the one or more processors determine whether words spoken by the user are directed to at least one companion electronic device or to an object situated within the environment. At 812, When the words spoken by the user are directed to the object situated within the environment, the one or more processors deliver other signals to the pair of companion electronic devices causing the pair of companion electronic devices to transition from a noise canceling mode of operation to a transparency mode of operation.

At 813, the other signals of 812 further cause the pair of companion electronic devices to reduce a volume level of the audio content. At 814, the one or more processors of 812 determine that the user is speaking to the environment of the electronic device from signals received from at least one companion electronic device of the pair of companion electronic devices.

At 815, in response to additional signals received from the at least one companion electronic device of the pair of companion electronic devices of 812 indicating a cessation of the user speaking to the environment, the one or more processors cause the pair of companion electronic devices to transition from the transparency mode of operation to the noise canceling mode of operation. At 816, the additional signals of 812 indicate that a predefined gesture input has been received by the at least one companion electronic device of the pair of companion electronic devices.

At 817, a method in an electronic device comprises determining, with a communication device paired with a companion electronic device pair, that the companion electronic device pair is delivering audio content to a user while operating in a noise canceling mode of operation. At 817, the method comprises determining, from signals received by the communication device from one or both companion electronic devices of the companion electronic device pair, that the user is speaking while the companion electronic device pair is delivering the audio content to the user while operating in the noise canceling mode of operation.

At 817, the method comprises affirming, by one or more processors, that words spoken by the user are not directed to either companion electronic device of the companion electronic device pair. At 817, when the one or more processors affirm the words spoken by the user are not directed to the either companion electronic device of the companion electronic device pair, the method comprises causing, by the one or more processors by delivering other signals to the companion electronic device pair, the companion electronic device pair to transition from the noise canceling mode of operation to a transparency mode of operation.

At 818, the other signals of 817 further cause the companion electronic device pair to lower a volume level of the audio content. At 819, the method of 818 further comprises precluding delivery of the other signals when the audio content is being delivered by the communication device to the companion electronic device pair by an application operating on the one or more processors that is actively using an audio input device of the companion electronic device pair as an input. At 820, the method of 818 further comprises precluding the delivery of the other signals when the audio content is a song and the words spoken by the user define lyrics to the song.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
determining, by one or more processors, that an audio output device of the electronic device is delivering audio content to a user while the electronic device is operating in a noise cancelation mode of operation;
determining, by the one or more processors from an audio input device of the electronic device, that the user is enunciating words;
determining, by the one or more processors, whether the words are directed to the audio input device of the electronic device or an environment of the electronic device; and
when the words are directed to the environment of the electronic device, causing, by the one or more processors, the electronic device to transition from the noise cancelation mode of operation to a transparency mode of operation while lowering a volume level associated with the audio content; and
when the words are directed to the audio input device of the electronic device, maintaining operation of the electronic device in the noise cancelation mode of operation.

2. The method of claim 1, wherein the lowering of the volume level comprises muting the volume level.

3. The method of claim 1, wherein the lowering of the volume level is achieved by pausing the delivering the audio content to the user by the audio output device.

4. The method of claim 1, wherein the causing the electronic device to transition from the noise cancelation mode of operation to the transparency mode of operation while lowering the volume level associated with the audio content occurs only when the electronic device is one electronic device of an electronic device pair and both electronic device of the electronic device pair are delivering the audio content to the user while operating in the noise cancelation mode of operation.

5. The method of claim 1, wherein the determining whether the words are directed to the audio input device of the electronic device, or the environment of the electronic device comprises determining the words are directed to the audio input device of the electronic device when an application operating on a companion electronic device actively in communication with the electronic device is utilizing the audio input device.

6. The method of claim 1, wherein the audio content comprises music and the determining whether the words are directed to the audio input device of the electronic device, or the environment of the electronic device comprises determining the words are directed to the audio input device of the electronic device when the words define lyrics to the music.

7. The method of claim 1, wherein the determining whether the words are directed to the audio input device of the electronic device, or the environment of the electronic device comprises determining the words are directed to the audio input device of the electronic device when the words define enunciations corresponding to the audio content.

8. The method of claim 7, wherein the enunciations correspond to the audio content when the enunciations define responses to calls defined by the audio content.

9. The method of claim 7, wherein the enunciations correspond to the audio content when the enunciations define exclamations in response to portions of the audio content.

10. The method of claim 1, wherein the determining whether the words are directed to the audio input device of the electronic device, or the environment of the electronic device comprises determining the words are directed to the environment when the audio input device receives acoustic input from a person other than the user within the environment.

11. The method of claim 1, further comprising:
also determining, by the one or more processors when the words are directed to the environment, that the user has ceased enunciating the words; and
also causing, by the one or more processors, the electronic device to transition from transparency mode of operation to the noise cancelation mode of operation while increasing the volume level associated with the audio content.

12. An electronic device, comprising:
a communication device; and
one or more processors operable with the communication device;
wherein the one or more processors, in response to determining a pair of companion electronic devices are in communication with the communication device are delivering audio content to a user while the pair of companion electronic devices operate in a noise cancelation mode of operation:
determine that the user is speaking to an environment of the electronic device;
determine whether words spoken by the user are directed to at least one companion electronic device or to an object situated within the environment; and
when the words spoken by the user are directed to the object situated within the environment, deliver other signals to the pair of companion electronic devices causing the pair of companion electronic devices to transition from a noise canceling mode of operation to a transparency mode of operation.

13. The electronic device of claim 12, wherein the other signals further cause the pair of companion electronic devices to reduce a volume level of the audio content.

14. The electronic device of claim 12, wherein the one or more processors determine that the user is speaking to the environment of the electronic device from signals received from at least one companion electronic device of the pair of companion electronic devices.

15. The electronic device of claim 12, wherein in response to additional signals received from the at least one companion electronic device of the pair of companion electronic devices indicating a cessation of the user speaking to the environment, the one or more processors cause the pair of companion electronic devices to transition from the transparency mode of operation to the noise canceling mode of operation.

16. The electronic device of claim 15, wherein the additional signals indicate that a predefined gesture input has been received by the at least one companion electronic device of the pair of companion electronic devices.

17. A method in an electronic device, the method comprising:
determining, with a communication device paired with a companion electronic device pair, that the companion electronic device pair is delivering audio content to a user while operating in a noise canceling mode of operation;
determining, from signals received by the communication device from one or both companion electronic devices of the companion electronic device pair, that the user is speaking while the companion electronic device pair is delivering the audio content to the user while operating in the noise canceling mode of operation;
affirming, by one or more processors, that words spoken by the user are not directed to either companion electronic device of the companion electronic device pair; and
when the one or more processors affirm the words spoken by the user are not directed to the either companion electronic device of the companion electronic device pair, causing, by the one or more processors by delivering other signals to the companion electronic device pair, the companion electronic device pair to transition from the noise canceling mode of operation to a transparency mode of operation.

18. The method of claim 17, wherein the other signals further cause the companion electronic device pair to lower a volume level of the audio content.

19. The method of claim 18, further comprising precluding delivery of the other signals when the audio content is being delivered by the communication device to the companion electronic device pair by an application operating on the one or more processors that is actively using an audio input device of the companion electronic device pair as an input.

20. The method of claim 18, further comprising precluding delivery of the other signals when the audio content is a song and the words spoken by the user define lyrics to the song.
